(19) United States
(12) Patent Application Publication
(10) Pub. No.: US 2018/0347451 A1
(43) Pub. Date: Dec. 6, 2018

(54) CYLINDER HEAD FOR AN INTERNAL COMBUSTION ENGINE, INTERNAL COMBUSTION ENGINE, AND METHOD FOR OPERATING AN INTERNAL COMBUSTION ENGINE

(71) Applicant: Dr. Ing. h.c. F. Porsche Aktiengesellschaft, Stuttgart (DE)

(72) Inventors: Andre Casal Kulzer, Boeblingen (DE); Jerome Munier, Gerlingen (DE)

(21) Appl. No.: 16/001,126

(22) Filed: Jun. 6, 2018

(30) Foreign Application Priority Data
Jun. 6, 2017 (DE) 10 2017 112 350.4

(51) Int. Cl. F02B 23/10; F02F 1/42

(52) U.S. Cl. CPC F02B 23/10; F01L 13/0015; F02B 2023/107; F02F 1/4235

(57) ABSTRACT

A cylinder head (4) for an internal combustion engine has a first inlet duct (8) that is configured to bring about a first tumbling movement and a second inlet duct (9) that is configured to bring about a second tumbling movement of the air quantities that flow through the cylinder head (4) and into a cylinder of the internal combustion engine (1). An internal combustion engine and a method for operating an internal combustion engine also are provided.

### CROSS REFERENCE TO RELATED APPLICATION

This application claims priority under 35 USC 119 to German Patent Appl. No. 10 2017 112 350.4 filed on Jun. 6, 2017, the entire disclosure of which is incorporated herein by reference.

### BACKGROUND

Field of the Invention. The invention relates to a cylinder head for an internal combustion engine. Furthermore, the invention relates to an internal combustion engine and to a method for operating an internal combustion engine.

Description of the Related Art. Cylinder heads for internal combustion engines have inlet and outlet ducts that are fit respectively with inlet and outlet valves for opening or closing the ducts. The ducts serve for a gas exchange of the internal combustion engine. Combustion air or a combustion air mixture can flow into a cylinder of the internal combustion engine via the associated inlet duct. The combustion air mixture combusts after a compression stroke of the internal combustion engine to form exhaust gas. The exhaust gas flows out via the outlet duct during the gas exchange phase that also includes an inflow of the combustion air or the combustion air mixture into the cylinder.

The combustion air mixture is composed of combustion air and fuel that fundamentally is not burned completely. Inlet ducts are shaped to achieve flow movements of the combustion air mixture that will improve homogenization of air and fuel in an effort to approach complete combustion.

Current internal combustion engines, such as direct injection gasoline engines swirl ducts, tumble ducts, reverse tumble ducts or combinations thereof that are intended to improve the mixing of air and fuel. A swirl duct is intended to be understood to bring about a charge movement with a flow that rotates about a cylinder axis. A tumble duct generates a circulating flow that is perpendicular to the swirl flow and brings about a movement in the clockwise direction. A charge movement generated by a reverse tumble duct takes place in a counterclockwise direction.

Internal combustion engine that have cylinders with two inlet ducts are disclosed in each of. DE 10 2014 101 379 A1, DE 10 2006 009 102 A1, DE 10 2013 100 902 A1, US 2014 352656 A1 and U.S. Pat. No. 5,394,845. One of the inlet ducts in each of the references is configured to bring about a swirl flow, and the other inlet duct is configured to bring about a tumbling flow.

US 2010/224166 A1 discloses an internal combustion engine with a cylinder that has an inlet duct configured to bring about a tumbling flow and an inlet duct configured to bring about a swirl flow. These two inlet ducts are not used at the same time, but rather predominantly in an alternating manner.

WO 2015/033198 A1 discloses an internal combustion engine having a cylinder head with a tumble valve that is configured independently of inlet valves in the inlet section. A regulating and control unit regulates the tumble valve in a manner that is dependent on a rotational speed of the internal combustion engine so that the air quantity that flows through one inlet duct into the cylinder has a first tumbling movement or a second tumbling movement in a time-dependent manner.

Valve arrangements for the inlet and outlet ducts of a cylinder head are disclosed in U.S. Pat. No. 5,394,845, U.S. Pat. No. 7,252,064, US 2010/0224166 and DE 10 2007 053 891.

DE 10 2009 015 639 A1 and DE 10 2007 053 891 B4 disclose internal combustion engines with a cylinder head that has a swirl flap. DE 10 2009 015 639 A1 also discloses a mask and an asymmetrical valve lift in conjunction with the swirl flap.

The disclosures of the documents identified above are incorporated herein by reference.

An object of the invention is to provide an improved cylinder head for an internal combustion engine. Other objects are to provide an internal combustion engine and a method for operating an internal combustion engine to reduce exhaust gas emissions.

### SUMMARY

A cylinder head according to the invention is for an internal combustion engine that has a crankcase with a cylinder and a piston that can be moved in an oscillating manner in the cylinder. The cylinder head has at least one outlet duct and two inlet ducts. The outlet duct can be opened or closed by an outlet valve, and each inlet ducts can be opened or closed by a respective inlet valve. The cylinder head, the cylinder and the piston form a combustion chamber. Each of the outlet valve and the inlet valves has a valve lift. The first inlet duct is configured to bring about a tumbling movement of the air quantity that flows through it into the cylinder, and the second inlet duct is configured to bring about a reverse tumbling movement of the air quantity that flows through it into the cylinder. The opposite tumbling movements enable the cylinder head to achieve a swirl movement of the air quantities that flow in via the two inlet ducts and also achieves an overall improved approximate homogenization and flow movement of the air quantity or charge in the combustion chamber of the cylinder. This leads to a considerably improved and more complete combustion of the cylinder charge and therefore a considerable reduction in exhaust gas emissions of the internal combustion engine that has the cylinder head of the invention.

The resulting swirl movement and the further movements of the charge that differ from the resulting swirl movement can be achieved particularly satisfactorily in an embodiment of the first inlet duct in the form of a tangential duct and/or an embodiment of the second inlet duct that is configured to change a direction of the air quantity. The directional change may be in the opposite direction relative to the direction of the air quantity that flows through the first inlet duct into the cylinder.

The directional change of the air quantity may be achieved by a planar face section on the second inlet duct in the region of an inlet opening of the second inlet duct.

Boosting of the charge movement may be achieved by configuring a first lift of the valve of the first inlet duct to differ from a second lift of the valve of the second inlet duct, thereby providing an asymmetry of the valve lifts of the inlet valves. As a result, different pressures prevail in the region of the inlet openings, and a corresponding movement of the charge in the cylinder is achieved up to pressure equalization. An advantageous charge movement results if the first lift is greater than the second lift.

A cover face which in the region of inlet openings of the inlet ducts may have a mask configured to face away from the combustion chamber or a mask configured to face the combustion chamber. The cover face may have a protuberance or an indentation. The mask also be described as lug-like. The advantage of said mask is to bring about a targeted change in the flow direction of the air quantity that flows out of the inlet ducts to achieve an improved movement of the charge in the combustion chamber.

In one embodiment, the mask is in a region of the further inlet opening that faces away from the first inlet duct. More particularly, the mask is in a region of the inlet opening of the inlet duct that is provided to bring about a reverse tumbling movement. In this way, the resulting swirl movement and the movement of the charge that is configured overall in the combustion chamber can be boosted, particularly in the case of valves with small valve lifts. The mask may be configured, starting from a cylinder edge that extends from the further inlet opening to the second outlet duct, so as to extend between the further inlet opening and the second outlet duct.

The cylinder head of one embodiment is used in an internal combustion engine that has a stroke/bore ratio with a value of less than or equal to 0.85, where the stroke describes a maximum possible axial movement of the piston in the cylinder and the bore describes a diameter of the cylinder. The cylinder head is particularly suitable for a stroke/bore ratio of the internal combustion engine of less than or equal to 0.75.

The invention also relates to a method for operating an internal combustion engine that has a crankcase and a piston that moves in an oscillating manner in a cylinder of the crankcase. The internal combustion engine also has a cylinder head with at least one outlet duct and two inlet ducts. The outlet duct may be opened or closed with the aid of an outlet valve and the inlet ducts may be opened or closed by respective inlet valves. The cylinder head, the cylinder and the piston form a combustion chamber. Each valve has a valve lift. An air quantity for combustion of a fuel quantity in the cylinder is sucked in by the cylinder via the inlet ducts. The overall air quantity consists of an air quantity that is sucked in via the first inlet duct and an air quantity that is sucked in from the second inlet duct, and the two air quantities that are sucked in have a certain movement in the cylinder. The method of the invention includes generating a tumbling movement of the air quantity that is sucked in via the first inlet duct and generating a reverse tumbling movement of the air quantity that is sucked in with the aid of the second inlet duct. An internal combustion engine that is operated in accordance with the method of the invention has a reduction in the exhaust gas emissions, in particular a CO₂ reduction, and a reduced the fuel consumption, particularly during full load operation.

The valve lifts of the valves of the inlet ducts may be set differently to improve the charge movement.

Power output and exhaust gas emissions of the internal combustion engine can be improved in the lower and medium part load range and rotational speed range of the internal combustion engine by setting the valve lift of the valve of the first inlet duct to be greater than the valve lift of the valve of the second inlet duct.

The second inlet duct may be closed during a gas exchange phase in a load range of from 0 to 30% of a full load of the internal combustion engine. Additionally, the valve lifts of the valves of the inlet ducts may be set differently in a load range of from 20 to 60% of a full load of the internal combustion engine.

Further features and details ar in the following description and the drawings. Features that are mentioned above and in the description in the following text and/or are shown in the figures alone can be used in the respectively specified combinations, in other combinations or on their own, without departing from the scope of the invention.

### BRIEF DESCRIPTION OF THE DRAWINGS

FIG. 1 is a plan view of a detail of a cylinder head of an internal combustion engine according to the invention.

FIG. 2 is a perspective view of a detail of the cylinder head of FIG. 1.

FIG. 3 is a perspective view of flow lines of a flow simulation in the cylinder head of FIG. 2.

FIG. 4 is a crank angle/valve lift diagram showing valve lifts of the internal combustion engine according to the invention.

### DETAILED DESCRIPTION

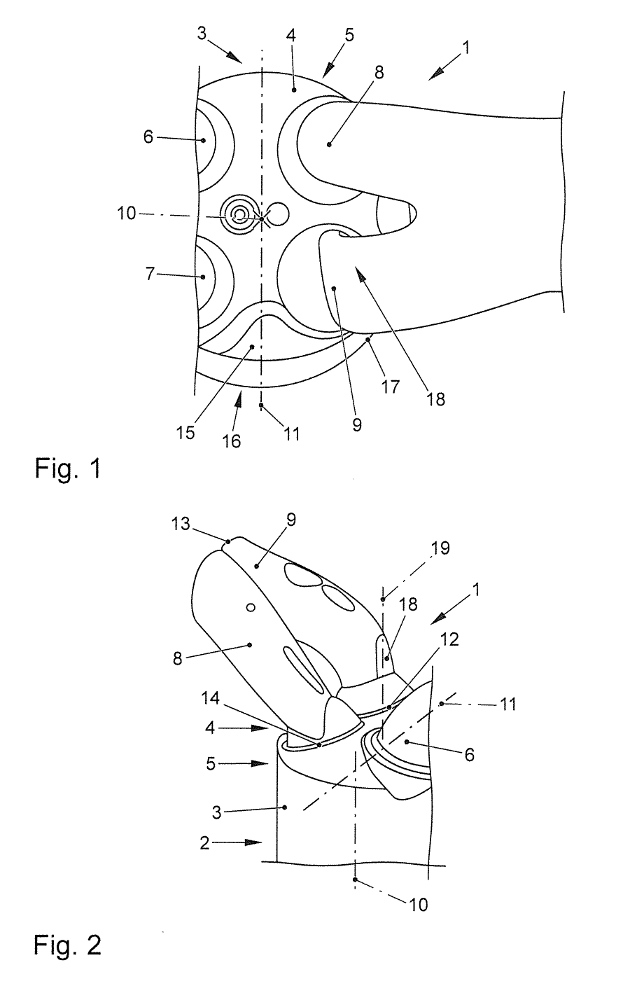

An internal combustion engine 1 according to the invention is illustrated in FIG. 1 and has a crankcase 2 with at least one cylinder 3. A piston can be moved in an oscillating manner in the cylinder 3. The piston is mounted in the crankcase 2 on a crankshaft. An end of the cylinder 3 that faces away from the crankshaft has a cylinder head 4, and a combustion chamber 5 is defined in the cylinder 3 between the piston and the cylinder head 4.

The cylinder head 4 comprises a first outlet duct 6, a second outlet duct 7, a first inlet duct 8 and a second inlet duct 9.

The ducts 6, 7, 8, 9 can be opened and closed with the aid of valves, such as those in the patent documents identified above. The valves are disk valves and each has a defined valve lift based on the possible axial movement along a longitudinal axis of the respective valve. The first outlet valve is assigned to the first outlet duct 6 and has an outlet valve lift HA that corresponds to the valve lift of the second outlet valve, which is assigned to the second outlet duct 7.

The first inlet valve is assigned to the first inlet duct 8 and has a first inlet valve lift HE1 that can differ from the second inlet valve lift HE2 of the second inlet valve 9 to achieve an asymmetry of the valve lifts of the inlet valves 8, 9. A reduced valve lift HE2′ of the second inlet valve 9 and a further reduced valve lift HE2″ of the second inlet valve 9 are illustrated in the crank angle/valve lift diagram of FIG. 4. It is not absolutely necessary that the internal combustion engine 1 has only one of the valve lifts HE2, HE2′, HE2″. For example, a variable valve lift might be realized with the aid of a variable camshaft or with the aid of a camshaft adjuster.

The first inlet duct 8 is configured as a tumbling duct or a tangential duct to bring about a tumbling movement of the air quantity that flows through the first inlet duct 8 and into the cylinder 3. Thus, a tumbling movement is imparted to the air quantity that flows through the first inlet duct 8 during the compression phase in the combustion chamber. The tumbling movement is a circulating movement that is in contrast to a swirl movement that is orientated in a rotational manner about a cylinder axis. Rather the tumbling movement takes place about a cylinder transverse axis 11 that is transverse to the cylinder axis 10.

The second inlet duct 9 is configured to form a reverse tumbling movement of the air quantity that flows through the second inlet duct 9 into the cylinder 3. This means that the direction of the reverse tumbling movement is opposed to the tumbling movement. Therefore, two tumbling movements can be brought about with the aid of the cylinder head 4 based on the corresponding design of the inlet ducts 8, 9.

As illustrated in FIGS. 1 and 2, the second inlet duct 9 is configured as a reverse tumble duct starting from an inlet opening 12 upstream of a duct inlet opening 13 of the second inlet duct 9 for streaming the air quantity the flows through it in a direction opposed from a cylinder center. Thus, the air quantity that flows through the first inlet duct 8 flows in a direction of the cylinder center, and the air quantity that flows through the second inlet duct 9 is conducted substantially in the opposite direction. To bring about the directional change, the second inlet duct 9 has a planar face section 18 close to the inlet opening 12. The planar face section 18 extends along an extent axis 19 that is approximately parallel to the cylinder axis 10. The extent axis 19 also could start from a surface point of the face section 18 that lies on the extent axis 19 in a manner that faces away from the inlet opening 12, so as to be inclined in the direction of a cylinder edge 17 of the cylinder 3, where the cylinder edge 17 faces away from the second outlet duct 7.

In principle, the inflow direction of the air quantity of the reverse tumble duct 9 into the combustion chamber 5 can be described as being directed counter to the tumble duct 8. That air quantity of the first inlet duct 8 that has the tumbling movement and that air quantity of the second inlet duct 9 which has the reverse tumbling movement meet one another in the combustion chamber 5, and further movements are initiated on account of the movements that are directed in an opposed manner. Substantially three movement forms or flows occur with different directions, namely: a tumbling movement that is configured obliquely in the combustion chamber 5, a pure tumbling movement that rotates about the cylinder transverse axis 11, and a resulting swirl movement of the air quantity that moves in the combustion chamber 5.

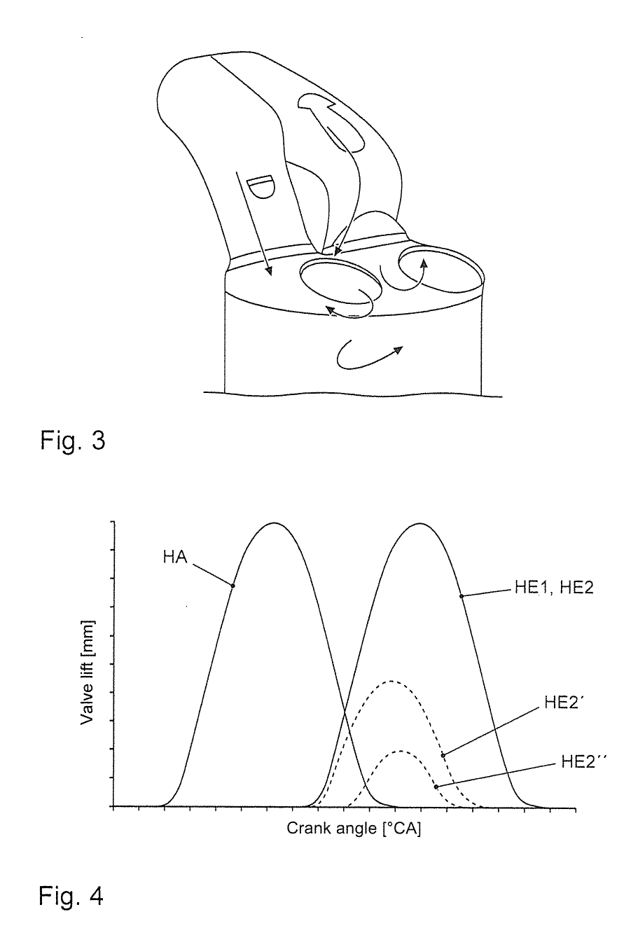

That air quantity proportion of the air quantity that is present in the combustion chamber 5 that has a swirl component or a swirl movement is fundamentally in the region of a piston crown of the piston. The piston crown is configured to face the combustion chamber 5, and on a cylinder head face of the cylinder head 4, where the cylinder head face delimits the combustion chamber 5. The tumbling movement of oblique configuration is present substantially on a cylinder wall of the cylinder 3, and the pure tumbling movement is present substantially in the center of the combustion chamber 5, as shown by way of example in FIG. 3.

An air movement that is substantially more stable than the tumbling movement in the form of a swirl movement, as is achieved with the combination of the tumbling movement and the reverse tumbling movement, can be improved in the low to medium load range and rotational speed range of the internal combustion engine 1 with the aid of an asymmetry of the valve lifts HE1, HE2 of the inlet valves.

The boosting of the resulting swirl movement is achieved if the first inlet valve lift HE1 of the valve of the first inflow duct 8 that is configured as a tangential duct is of greater configuration than the second inlet valve lift HE2 of the valve of the second inflow duct 9 which is configured to bring about a reverse tumbling movement. Therefore, the air quantity with the tumbling movement is greater than the air quantity that has the reverse tumbling movement, and the resulting swirl movement is boosted in comparison with equally great air quantities which flow through the inflow ducts 8, 9.

What is known as a zero lift of the valve of the second inflow duct 9 leads in a lowermost load range of the internal combustion engine 1 to a preferred resulting swirl movement in the combustion chamber 5. This is to be substantiated by the fact that the air quantity that flows through the first inflow duct 8 into the combustion chamber 5 has the tumbling movement and an increased propagation volume is available to it in the combustion chamber 5 on account of the closed second inflow duct 9, and a vacuum relative to the pressure in the region of the inlet opening 12 is present, as a result of which the tumbling movement is converted into the resulting swirl movement.

A mask 15 is configured in the region of the further inlet openings 14 in the combustion chamber 5 generates boosting of the resulting swirl movement, in particular in the case of reduced valve lifts of the valve of the second inlet duct 9. The mask 15 is in the form of a lug that protrudes into the combustion chamber 5. Additionally, the mask is configured on a cover face 16 of the combustion chamber 5 and particularly a cover face 16 assigned to the cylinder head 4. Starting from a cylinder edge 17, the mask 15 extends between the second outlet duct 7 and the second inlet duct 9. More particularly, starting from the cylinder edge 17 that extends from the further inlet opening 14 to the second outlet duct 7, the mask 15 is configured to extend between the further inlet opening 14 and the second outlet duct 7.

The method according to the invention and the internal combustion engine 1 according to the invention are advantageous, in particular, in the case of a stroke/bore ratio of the internal combustion engine 1 having a value of less than or equal to 1.0.

The method according to the invention for operating the internal combustion engine 1 is distinguished by the fact that a tumbling movement of the air quantity that is sucked in via the first inlet duct 8 is generated with the aid of the first inlet duct 8, and a reverse tumbling movement of the air quantity that is sucked in is generated with the aid of the second inlet duct 9. This preferably takes place by way of the correspondingly shaped inlet ducts 8, 9, but might also be brought about in a different way.

To achieve advantageous reduced emissions in the low to medium part load range and rotational speed range of the internal combustion engine 1, the valve lifts HE1, HE2 of the valves of the inlet ducts 8, 9 are set differently. In particular, the first valve lift HE1 of the first inlet duct 8 has a greater value than the second valve lift HE2 of the second inlet duct 9. This means that, in the lower and medium part load range and rotational speed range of the internal combustion engine 1, the first valve lift HE1 of the valve of the first inlet duct 8 is set to be greater than the second valve lift HE2 of the valve of the second inlet duct 9. The second valve lift HE2 might correspond to a reduced valve lift HE2′ or a further-reduced valve lift HE2″.

The first valve lift HE1 might also be a maximum valve lift of the valve of the first inlet duct 8 and its value might remain unchanged, the value of the second valve lift HE2 being reduced, however. That is to say, in other words, that, in the lower and medium load range and/or rotational speed range, the first valve lift HE1 does not necessarily have to be the maximum possible valve lift of the first inlet valve. A difference between the valve lifts of the inlet valves is necessary to achieve the advantages of the method according to the invention, it being necessary for the valve lift of the first inlet valve to be greater than the valve lift of the second inlet valve.

In a further embodiment of the method according to the invention, the second inlet duct 9 remains closed in the gas exchange phase in a load range of from 0 to 30% of a full load of the internal combustion engine 1. That is to say, that exclusively the first inlet duct 8 is opened and no air quantity can be sucked in by the cylinder 3 via the second inlet duct 9.

The valve lifts HE1, HE2 of the valves of the inlet ducts 8, 9 might likewise be set differently, in particular in a load range of from 20 to 60% of a full load of the internal combustion engine 1.

### LIST OF DESIGNATIONS

1 Internal combustion engine

2 Crankcase

3 Cylinder

4 Cylinder head

5 Combustion chamber

6 First outlet duct

7 Second outlet duct

8 First inlet duct

9 Second inlet duct

10 Cylinder axis

11 Cylinder transverse axis

12 Inlet opening

13 Duct inlet opening

14 Further inlet opening

15 Mask

16 Cover face

17 Cylinder edge

18 Face section

19 Extent axis

HA Outlet valve lift

HE1 First inlet valve lift

HE2 Second inlet valve lift

HE2′ Reduced valve lift, second inlet valve

HE2″ Further-reduced valve lift, second inlet valve

What is claimed is:

1. A cylinder head for an internal combustion engine that has a crankcase with a cylinder having a piston that moves in the cylinder in an oscillating manner, the cylinder head comprising at least one outlet duct that is selectively openable and closeable and first and second inlet ducts that are selectively openable closeable, the cylinder head, the cylinder and the piston forming a combustion chamber, wherein the first inlet duct is configured to generate a first tumbling movement of an air quantity that flows through the first inlet duct and into the cylinder, and the second inlet duct being configured to generate a second tumbling movement of the air quantity that flows through the second inlet duct and into the cylinder.

2. The cylinder head of claim 1, wherein the first inlet duct is a tangential duct and is configured to bring about a directional change of the air quantity in comparison with the first inlet duct.

3. The cylinder head of claim 2, wherein the second inlet duct has a planar face section to bring about the directional change of the air quantity.

4. The cylinder head of claim 1, wherein the first inlet duct has a first inlet valve with a first lift and the second inlet duct has a second inlet valve.

5. The cylinder head of claim 4, wherein the first lift is greater than the second lift.

6. The cylinder head of claim 4, wherein the first lift is equal to the second lift.

7. The cylinder head of claim 4, wherein the valve lifts are adjustable.

8. The cylinder head of claim 1, further comprising a cover face in a region of first or second inlet openings of the first and second inlet ducts respectively and has a mask facing toward or away from the combustion chamber.

9. The cylinder head of claim 8, wherein the mask is configured in a region of the second inlet opening that faces away from the first inlet duct.

10. The cylinder head of claim 8, wherein the mask is configured, starting from a cylinder edge that extends from the second inlet opening to the second outlet duct and between the second inlet opening and the second outlet duct.

11. The cylinder head of claim 1, wherein the internal combustion engine has a stroke/bore ratio with a value of less than or equal to 1.0.

12. An internal combustion engine, having a crankcase and the cylinder head of claim 1.

13. A method for operating an internal combustion engine, the internal combustion engine having a crankcase that has a cylinder with a piston that moves in the cylinder in an oscillating manner, and a cylinder head that has at least one outlet duct and two inlet ducts, an outlet valve for selectively opening and closing the outlet duct and inlet valves for selectively opening and closing the inlet ducts, the cylinder head, the cylinder and the piston defining a combustion chamber, and each valve having a valve lift, an overall air quantity for the combustion of a fuel quantity in the cylinder being sucked in via the inlet ducts, and the overall air quantity consisting of an air quantity that is sucked in via the first inlet duct and an air quantity that is sucked in from the second inlet duct, and the two air quantities that are sucked in having a certain movement in the cylinder, the method comprising:
using the first inlet duct for generating a tumbling movement of the air quantity that is sucked in via the first inlet duct, and
using the second inlet duct for generating a reverse tumbling movement of the air quantity that is sucked in via the second inlet duct.

14. The method of claim 13, wherein the valve lifts of the valves of the inlet ducts are set differently.

15. The method of claim 14, wherein in a lower and medium part load range and rotational speed range of the internal combustion engine, the valve lift of the valve of the first inlet duct (8) is set to be greater than the valve lift of the valve of the second inlet duct.

16. The method of claim 15, wherein in a load range of from 0% to 30% of a full load of the internal combustion engine, the second inlet duct remains closed in a gas exchange phase.

17. The method of claim 13, wherein in a load range of from 20 to 60% of a full load of the internal combustion engine, the valve lifts of the valves of the inlet ducts are set differently.
